(19) United States
(12) Patent Application Publication
(10) Pub. No.: US 2024/0129490 A1
(43) Pub. Date: Apr. 18, 2024

(54) IMAGE DECODING DEVICE, IMAGE DECODING METHOD, AND PROGRAM

(71) Applicant: KDDI CORPORATION, Tokyo (JP)

(72) Inventor: Yoshitaka KIDANI, Fujimino-shi (JP)

(73) Assignee: KDDI CORPORATION, Tokyo (JP)

(21) Appl. No.: 18/394,445

(22) Filed: Dec. 22, 2023

Related U.S. Application Data
(63) Continuation of application No. PCT/JP2022/026210, filed on Jun. 30, 2022.

(30) Foreign Application Priority Data
Jun. 30, 2021 (JP) 2021-109715

(51) Int. Cl. H04N 19/159; H04N 19/176; H04N 19/70

(52) U.S. Cl. CPC H04N 19/159; H04N 19/176; H04N 19/70

(57) ABSTRACT

An image decoding device includes a decoding unit configured to decode a first syntax for controlling possibility of application of a geometric partitioning mode of a decoding target sequence, and to control whether to decode a second syntax for controlling possibility of application of an intra prediction mode to the geometric partitioning mode of the decoding target sequence according to a value of the first syntax.

### CROSS-REFERENCE TO RELATED APPLICATIONS

The present application is a continuation of PCT Application No. PCT/JP2022/026210, filed on Jun. 30, 2022, which claims the benefit of Japanese patent application No. 2021-109715 filed on Jun. 30, 2021, the entire contents of which are incorporated herein by reference in its entirety.

### TECHNICAL FIELD

The present invention relates to an image decoding device, an image decoding method, and a program.

### BACKGROUND ART

Non Patent Reference 1 (ITU-T H.266/VVC) discloses a geometric partitioning mode (GPM).

The GPM diagonally divides a rectangular block into two and performs motion compensation on each of the two blocks. Specifically, in the GPM, each of the two partitioned regions is motion-compensated by a motion vector in a merge mode, and is synthesized by weighted averaging. As the oblique partitioning pattern, sixty-four patterns are prepared according to the angle and the position.

### SUMMARY OF THE INVENTION

However, since the GPM disclosed in Non Patent Reference 1 is limited to the merge mode, there is a problem that there is room for improvement in encoding performance.

Therefore, the present invention has been made in view of the above-described problems, and an object of the present invention is to provide an image decoding device, an image decoding method, and a program with which it is possible to expect further improvement in encoding performance by GPM by specifying a signaling method when an intra prediction mode is added to GPM so that whether GPM can be applied to a decoding target block and a type of a prediction mode for each partitioned region when GPM is applied are appropriately specified.

The first aspect of the present invention is summarized as an image decoding device including: a circuit, wherein the circuit decodes a first syntax for controlling possibility of application of a geometric partitioning mode of a decoding target sequence, and control whether to decode a second syntax for controlling possibility of application of an intra prediction mode to the geometric partitioning mode of the decoding target sequence according to a value of the first syntax.

The second aspect of the present invention is summarized as an image decoding method, including decoding a first syntax for controlling possibility of application of a geometric partitioning mode of a decoding target sequence; and controlling whether to decode a second syntax for controlling possibility of application of an intra prediction mode to the geometric partitioning mode of the decoding target sequence according to a value of the first syntax.

The third aspect of the present invention is summarized as a program stored on a non-transitory computer-readable medium for causing a computer to function as an image decoding device, the image decoding device comprising a circuit, wherein: the circuit decodes a first syntax for controlling possibility of application of a geometric partitioning mode of a decoding target sequence, and control whether to decode a second syntax for controlling possibility of application of an intra prediction mode to the geometric partitioning mode of the decoding target sequence according to a value of the first syntax.

According to the present invention, it is possible to provide an image decoding device, an image decoding method, and a program with which it is possible to expect further improvement in encoding performance by GPM by specifying a signaling method when an intra prediction mode is added to GPM so that whether GPM can be applied to a decoding target block and a type of a prediction mode for each partitioned region when GPM is applied are appropriately specified.

### BRIEF DESCRIPTION OF THE DRAWINGS

FIG. 1 is a diagram illustrating an example of a configuration of an image processing system 1 according to an embodiment.

FIG. 2 is a diagram illustrating an example of functional blocks of an image encoding device 100 according to an embodiment.

FIG. 3 is a diagram illustrating an example of functional blocks of an image decoding device 200 according to an embodiment.

FIG. 4 is a diagram illustrating an example of a case where a rectangular decoding target block is partitioned into two regions of partitioned region 0 and partitioned region 1 of a geometric shape by a partitioning line of a geometric partitioning mode according to the geometric partitioning mode disclosed in Non Patent Reference 1.

FIG. 5 is a diagram illustrating an example of application of an intra prediction mode to a GPM according to the present embodiment.

FIG. 6 is a diagram illustrating an example of a configuration of encoded data received by a decoding unit 210 disclosed in Non Patent Reference 1.

FIG. 7 is a flowchart illustrating an example of a method in which the decoding unit 210 specifies whether the GPM can be applied and whether the intra prediction mode can be applied to the GPM on the basis of a GPM-related flag in units of SPS.

FIG. 8 is a modified example of FIG. 7.

FIG. 9 is a flowchart illustrating an example of a method for determining whether the decoding unit 210 applies the GPM to a decoding target block.

FIG. 10 is a flowchart illustrating an example of a method in which the decoding unit 210 determines a GPM partitioning mode (a type of a partitioning line) for each block of a decoding target block.

FIG. 11 is a flowchart illustrating a method in which the decoding unit 210 determines whether to apply the intra prediction mode to partitioned region 0.

FIG. 12 is a flowchart illustrating a method in which the decoding unit 210 determines whether to apply the intra prediction mode to partitioned region 1.

FIG. 13 is a flowchart illustrating an example of a method in which the decoding unit 210 specifies a prediction mode in partitioned region 0 when there is one type of GPM-applied intra prediction mode.

FIG. 14 is a flowchart illustrating an example of a method in which the decoding unit 210 specifies a prediction mode in partitioned region 1 when there is one type of GPM-applied intra prediction mode.

FIG. 15 is a flowchart illustrating an example of a method in which the decoding unit 210 specifies a prediction mode in partitioned region 0 when there are two or more types of GPM-applied intra prediction modes.

FIG. 16 is a flowchart illustrating an example of a method in which the decoding unit 210 specifies a prediction mode in partitioned region 1 when there are two or more types of GPM-applied intra prediction modes.

### DESCRIPTION OF EMBODIMENTS

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

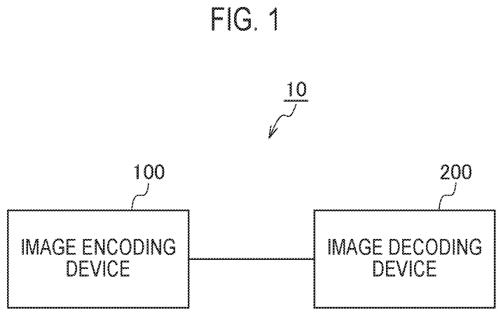

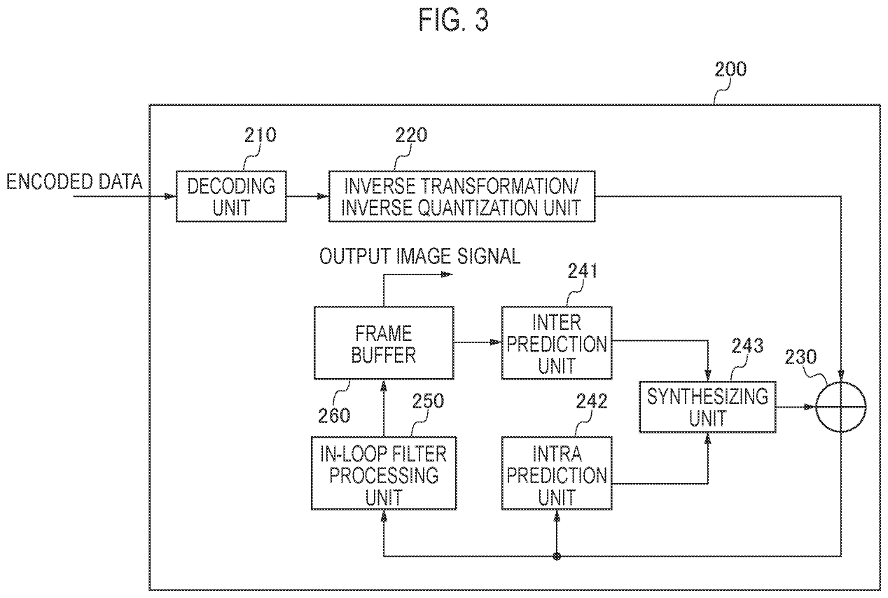

Hereinafter, an image processing system 10 according to a first embodiment of the present invention will be described with reference to FIGS. 1 to 7. FIG. 1 is a diagram illustrating the image processing system 10 according to the present embodiment.

(Image Processing System 100)

As illustrated in FIG. 1, the image processing system 10 according to the present embodiment includes an image coding device 100 and an image decoding device 200.

The image coding device 100 is configured to generate coded data by coding an input image signal (picture). The image decoding device 200 is configured to generate an output image signal by decoding the coded data.

The coded data may be transmitted from the image coding device 100 to the image decoding device 200 via a transmission path. The coded data may be stored in a storage medium and then provided from the image coding device 100 to the image decoding device 200.

(Image Coding Device 100)

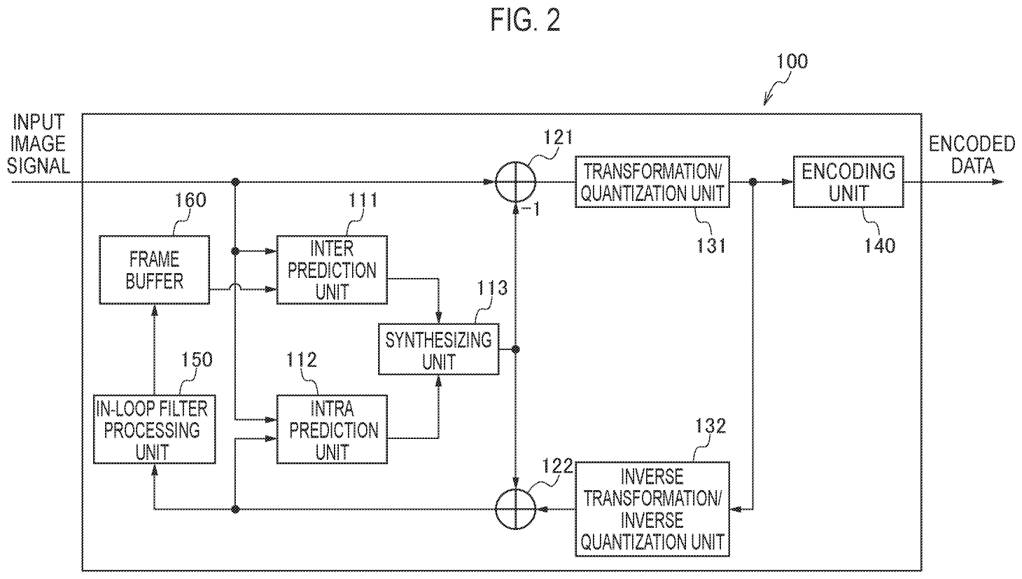

Hereinafter, the image coding device 100 according to the present embodiment will be described with reference to FIG. 2. FIG. 2 is a diagram illustrating an example of functional blocks of the image coding device 100 according to the present embodiment.

As shown in FIG. 2, the image coding device 100 includes an inter prediction unit 111, an intra prediction unit 112, a subtractor 121, an adder 122, a transform/quantization unit 131, an inverse transform/inverse quantization unit 132, a coding unit 140, an in-loop filtering processing unit 150, and a frame buffer 160.

The inter prediction unit 111 is configured to generate a prediction signal by inter prediction (inter-frame prediction).

Specifically, the inter prediction unit 111 is configured to specify a reference block included in a reference frame by comparing a frame to be coded (hereinafter, referred to as a target frame) with the reference frame stored in the frame buffer 160, and determine a motion vector (mv) for the specified reference block. Here, the reference frame is a frame different from the target frame.

The inter prediction unit 111 is configured to generate the prediction signal included in a block to be coded (hereinafter, referred to as a target block) for each target block based on the reference block and the motion vector.

The inter prediction unit 111 is configured to output the inter prediction signal to synthesizing unit 113.

Although not illustrated in FIG. 2, the inter prediction unit 111 is configured to output information related to inter prediction control (specifically, information such as an inter prediction mode, a motion vector, a reference frame list, and a reference frame number) to the encoding unit 140.

The intra prediction unit 112 is configured to generate a prediction signal by intra prediction (intra-frame prediction).

Specifically, the intra prediction unit 112 is configured to specify the reference block included in the target frame, and generate the prediction signal for each target block based on the specified reference block. Here, the reference block is a block referred to for the target block. For example, the reference block is a block adjacent to the target block.

Furthermore, the intra prediction unit 112 is configured to output the intra prediction signal to the synthesizing unit 113.

Furthermore, although not illustrated in FIG. 2, the intra prediction unit 112 is configured to output information (specifically, information such as an intra prediction mode) regarding control of intra prediction to the encoding unit 140.

The synthesizing unit 113 is configured to synthesize the inter prediction signal input from the inter prediction unit 111 and/or the intra prediction signal input from the intra prediction unit 112 using a preset weighting factor, and output the synthesized prediction signal (hereinafter, collectively referred to as a prediction signal) to the subtractor 121 and the adder 122.

Here, regarding the synthesizing processing of the inter prediction signal and/or the intra prediction signal by the synthesizing unit 113, the same configuration as that of Non Patent Reference 1 can be adopted in the present embodiment, and thus the description thereof will be omitted.

The subtractor 121 is configured to subtract the prediction signal from the input image signal, and output a prediction residual signal to the transform/quantization unit 131. Here, the subtractor 121 is configured to generate the prediction residual signal that is a difference between the prediction signal generated by intra prediction or inter prediction and the input image signal.

The adder 122 is configured to add the prediction signal output from the synthesizing unit 113 to the prediction residual signal output from the inverse transformation/inverse quantization unit 132 to generate a decoded signal before filtering, and output the decoded signal before filtering to the intra prediction unit 112 and the in-loop filter processing unit 150.

Here, the pre-filtering decoded signal constitutes the reference block used by the intra prediction unit 112.

The transform/quantization unit 131 is configured to perform transform processing for the prediction residual signal and acquire a coefficient level value. Furthermore, the transform/quantization unit 131 may be configured to perform quantization of the coefficient level value.

Here, the transform processing is processing of transforming the prediction residual signal into a frequency component signal. In such transform processing, a base pattern (transformation matrix) corresponding to discrete cosine transform (Hereinafter referred to as DCT) may be used, or a base pattern (transformation matrix) corresponding to discrete sine transform (Hereinafter referred to as DST) may be used.

Furthermore, as the transform processing, multiple transform selection (MTS) that enables selection of a transform basis suitable for deviation of the coefficient of the prediction residual signal from the plurality of transform bases disclosed in Non Patent Reference 1 for each of the horizontal and vertical directions, or low frequency-non-separable transform (LFNST) that improves the encoding performance by further concentrating the transform coefficient after the primary transform in the low frequency region may be used.

The inverse transform/inverse quantization unit 132 is configured to perform inverse transform processing for the coefficient level value output from the transform/quantization unit 131. Here, the inverse transform/inverse quantization unit 132 may be configured to perform inverse quantization of the coefficient level value prior to the inverse transform processing.

Here, the inverse transform processing and the inverse quantization are performed in a reverse procedure to the transform processing and the quantization performed by the transform/quantization unit 131.

The coding unit 140 is configured to code the coefficient level value output from the transform/quantization unit 131 and output coded data.

Here, for example, the coding is entropy coding in which codes of different lengths are assigned based on a probability of occurrence of the coefficient level value.

Furthermore, the coding unit 140 is configured to code control data used in decoding processing in addition to the coefficient level value.

Here, the control data may include size data such as a coding block (coding unit (CU)) size, a prediction block (prediction unit (PU)) size, and a transform block (transform unit (TU)) size.

Furthermore, the control data may include information (flag and index) necessary for control of the inverse transformation/inverse quantization processing of the inverse transformation/inverse quantization unit 220, the inter prediction signal generation processing of the inter prediction unit 241, the intra prediction signal generation processing of the intra prediction unit 242, the synthesis processing of the inter prediction signal or/and the intra prediction signal of the synthesizing unit 243, the filter processing of the in-loop filter processing unit 250, and the like in the image decoding device 200 described later.

Note that, in Non Patent Reference 1, these pieces of control data are referred to as syntaxes, and the definition thereof is referred to as semantics.

Furthermore, the control data may include header information such as a sequence parameter set (SPS), a picture parameter set (PPS), and a slice header as described later.

The in-loop filtering processing unit 150 is configured to execute filtering processing on the pre-filtering decoded signal output from the adder 122 and output the filtered decoded signal to the frame buffer 160.

Herein, for example, the filter processing is deblocking filter processing, which reduces the distortion generated at boundary parts of blocks (encoded blocks, prediction blocks, or conversion blocks), or adaptive loop filter processing, which switches filters based on filter coefficients, filter selection information, local properties of picture patterns of an image, etc. transmitted from the image encoding device 100.

The frame buffer 160 is configured to accumulate the reference frames used by the inter prediction unit 111.

Here, the filtered decoded signal constitutes the reference frame used by the inter prediction unit 111.

(Image Decoding Device 200)

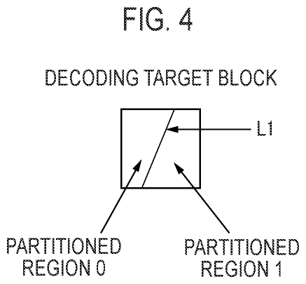

Hereinafter, the image decoding device 200 according to the present embodiment will be described with reference to FIG. 4. FIG. 4 is a diagram illustrating an example of functional blocks of the image decoding device 200 according to the present embodiment.

As illustrated in FIG. 4, the image decoding device 200 includes a decoding unit 210, an inverse transform/inverse quantization unit 220, an adder 230, an inter prediction unit 241, an intra prediction unit 242, an in-loop filtering processing unit 250, and a frame buffer 260.

The decoding unit 210 is configured to decode the coded data generated by the image coding device 100 and decode the coefficient level value.

Here, the decoding is, for example, entropy decoding performed in a reverse procedure to the entropy coding performed by the coding unit 140.

Furthermore, the decoding unit 210 may be configured to acquire control data by decoding processing for the coded data.

Here, the control data may include information related to the block size of the decoded block (synonymous with a block to be encoded in the above-described image encoding device 100, hereinafter, collectively referred to as a target block) described above.

Furthermore, the control data may include information (flag or index) necessary for control of the inverse transformation/inverse quantization processing of the inverse transformation/inverse quantization unit 220, the predicted pixel generation processing of the inter prediction unit 241 or the intra prediction unit 242, the filter processing of the in-loop filter processing unit 250, and the like.

Furthermore, the control data may include header information such as a sequence parameter set (SPS), a picture parameter set (PPS), a picture header (PH), or a slice header (SH) described above.

The inverse transform/inverse quantization unit 220 is configured to perform inverse transform processing for the coefficient level value output from the decoding unit 210. Here, the inverse transform/inverse quantization unit 220 may be configured to perform inverse quantization of the coefficient level value prior to the inverse transform processing.

Here, the inverse transform processing and the inverse quantization are performed in a reverse procedure to the transform processing and the quantization performed by the transform/quantization unit 131.

The adder 230 is configured to add the prediction signal to the prediction residual signal output from the inverse transform/inverse quantization unit 220 to generate a pre-filtering decoded signal, and output the pre-filtering decoded signal to the intra prediction unit 242 and the in-loop filtering processing unit 250.

Here, the pre-filtering decoded signal constitutes a reference block used by the intra prediction unit 242.

Similarly to the inter prediction unit 111, the inter prediction unit 241 is configured to generate a prediction signal by inter prediction (inter-frame prediction).

Specifically, the inter prediction unit 241 is configured to generate the prediction signal for each prediction block based on the motion vector decoded from the coded data and the reference signal included in the reference frame. The inter prediction unit 241 is configured to output the prediction signal to the adder 230.

Similarly to the intra prediction unit 112, the intra prediction unit 242 is configured to generate a prediction signal by intra prediction (intra-frame prediction).

Specifically, the intra prediction unit 242 is configured to specify the reference block included in the target frame, and generate the prediction signal for each prediction block based on the specified reference block. The intra prediction unit 242 is configured to output the prediction signal to the adder 230.

Like the synthesizing unit 113, the synthesizing unit 243 is configured to synthesize the inter prediction signal input from the inter prediction unit 111 and/or the intra prediction signal input from the intra prediction unit 112 using a preset weighting factor, and output the synthesized prediction signal (hereinafter, collectively referred to as a prediction signal) to the adder 122.

The adder 122 is configured to add the prediction signal output from the synthesizing unit 243 to the prediction residual signal output from the inverse transform/inverse quantization unit 220 to generate a pre-filtering decoded signal, and output the pre-filtering decoded signal to the in-loop filtering processing unit 250.

Similarly to the in-loop filtering processing unit 150, the in-loop filtering processing unit 250 is configured to execute filtering processing on the pre-filtering decoded signal output from the adder 230 and output the filtered decoded signal to the frame buffer 260.

Herein, for example, the filter processing is deblocking filter processing, which reduces the distortion generated at boundary parts of blocks (encoded blocks, prediction blocks, conversion blocks, or sub-blocks obtained by dividing them), or adaptive loop filter processing, which switches filters based on filter coefficients, filter selection information, local properties of picture patterns of an image, etc. transmitted from the image encoding device 100.

Similarly to the frame buffer 160, the frame buffer 260 is configured to accumulate the reference frames used by the inter prediction unit 241.

Here, the filtered decoded signal constitutes the reference frame used by the inter prediction unit 241.

(Geometric Partitioning Mode)

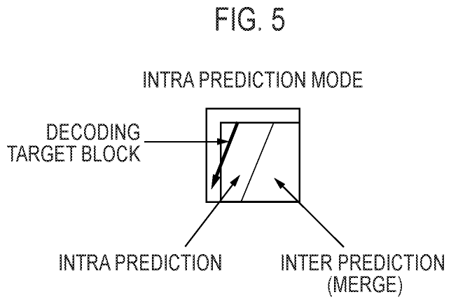

Hereinafter, with reference to FIGS. 4 and 5, application of the geometric partitioning mode disclosed in Non Patent Reference 1 related to the decoding unit 210, the inter prediction unit 241, and the intra prediction unit 242 and the first geometric partitioning mode (GPM) according to the present embodiment to the intra prediction mode will be described.

FIG. 4 illustrates an example of a case where a rectangular decoding target block is partitioned into two regions of partitioned region 0 and partitioned region 1 of a geometric shape by a partitioning line L1 of the geometric partitioning mode according to the geometric partitioning mode disclosed in Non Patent Reference 1.

Here, sixty-four patterns of the partitioning line L1 of the geometric partitioning mode disclosed in Non Patent Reference 1 are prepared according to the angle and the position.

Furthermore, the GPM according to Non Patent Reference 1 applies a normal merge mode, which is a type of inter prediction, to each of the partitioned region 0 and the partitioned region 1 to generate an inter predicted (motion-compensated) pixel.

Specifically, in such a GPM, a merge candidate list disclosed in Non Patent Reference 1 is constructed, a motion vector and a reference frame of each partitioned region 0/1 are derived on the basis of the merge candidate list and the merge index transmitted from the image encoding device 100, and a reference block, that is, an inter predicted (or motion compensated) block is generated. Finally, the inter predicted pixels of each partitioned region 0/1 are weight-averaged by a preset weight and synthesized.

Since the method disclosed in Non Patent Reference 1 can be applied to the present invention, the detailed description of the method for constructing the merge candidate list is omitted.

FIG. 5 illustrates an example of application of the intra prediction mode to the GPM according to the present embodiment.

Since the predicted pixel generation of the GPM according to Non Patent Reference 1 is limited to the normal merge mode, which is a type of inter prediction (motion compensation), there is room for improvement in encoding performance.

On the other hand, the first GPM according to the present embodiment proposes improvement of the encoding performance by applying an intra prediction mode in addition to the normal merge mode to generate the predicted pixel of the GPM.

Here, in the first GPM, either the normal merge mode or the intra prediction mode can be applied to each partitioned region 0/1, and the type of the intra prediction mode is limited according to the partitioning shape (partitioning line) of the decoding target block.

In addition, the second GPM according to the present embodiment proposes a method of specifying the possibility of application of the GPM to which the intra prediction mode is additionally applied in the decoding target block and the prediction mode type in each of the partitioned regions 0/1 when the GPM is applied.

In this way, the GPM to which the intra prediction mode is additionally applied is appropriately applied to the decoding target block, and the optimum prediction mode is specified, so that the encoding performance can be further improved.

Hereinafter, the method of specifying the possibility of application of the GPM in the second GPM and the prediction mode type in each partitioned region 0/1 when the GPM is applied (or a generally called signaling method) according to the present embodiment will be described from two viewpoints of the specifying method based on the encoded data (encoded bit stream) itself decoded by the decoding unit 210 and the control data (syntax) included in the encoded data in the decoding unit 210.

(Encoded Data Decoded by Decoding Unit 210)

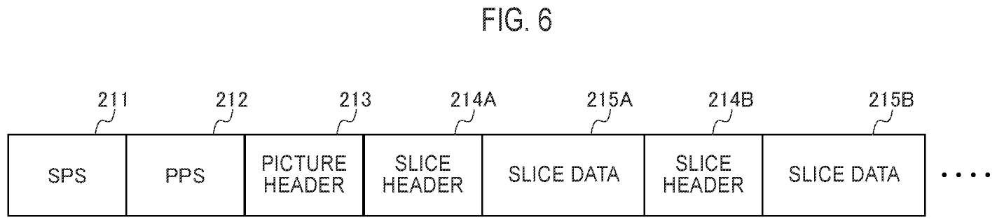

Hereinafter, encoded data decoded by the decoding unit 210 will be described with reference to FIG. 6. FIG. 6 is a diagram illustrating an example of a configuration of encoded data received by the decoding unit 210 disclosed in Non Patent Reference 1.

As illustrated in FIG. 6, the encoded data may include an SPS 211 at the head of the stream. The SPS 211 is a set of control data in units of sequences (sets of pictures). Each SPS 211 includes at least SPS id information for individually identifying a plurality of SPSs.

As illustrated in FIG. 6, the encoded data may include a PPS 212 next to the SPS 211. Here, the PPS 212 is a set of control data in units of pictures (sets of slices). Each PPS 212 includes at least PPS id information for identifying each PPS 212 when there are a plurality of PPS. In addition, at least SPS id information for designating the SPS 211 corresponding to each PPS 212 is included.

As illustrated in FIG. 6, the encoded data may include a picture header 213 next to the PPS 212. The picture header 213 is also a set of control data in units of pictures (sets of slices). The PPS 212 may share a single PPS 212 for multiple pictures. On the other hand, the picture header 213 is always transmitted for each picture. The picture header 213 includes at least PPS id information for designating the PPS 212 corresponding to each picture.

As illustrated in FIG. 6, the encoded data may include a slice header 213 next to the picture header 214A. The slice header 214A is a set of control data in units of slices. The slice header 214A can also include information of the picture header 213 described above as part of the slice header.

As illustrated in FIG. 6, the encoded data may include slice data 215A next to the slice header 214A. The slice data 215A may include the above-described coefficient level value, size data, and the like.

As described above, one slice header, one picture header, one PPS, and one SPS correspond to each piece of slice data 215A/215B. As described above, since which PPS 212 will be referred to in the picture header 213 is designated by the PPS id, and which SPS 211 will be referred to by the PPS 212 is designated by the SPS id, the SPS 211 and the PPS 212 common to the plurality of pieces of slice data 215A/215B can be used.

In other words, the SPS 211 and the PPS 212 do not necessarily need to be transmitted for each picture and for each slice. For example, as illustrated in FIG. 6, a stream configuration may be employed in which the SPS 211 and the PPS 212 are not encoded immediately before the slice headers 214A/214B.

Note that the configuration illustrated in FIG. 6 is merely an example. As long as the control data designated by the slice headers 214A/214B, the picture header 213, the PPS 212, and the SPS 211 correspond to each piece of slice data 215A/215B, elements other than these may be added as the components of the stream. Similarly, the configuration may be shaped into a configuration different from that in FIG. 6 at the time of transmission.

(Method for Specifying Applicability of GPM in Units of Sequences)

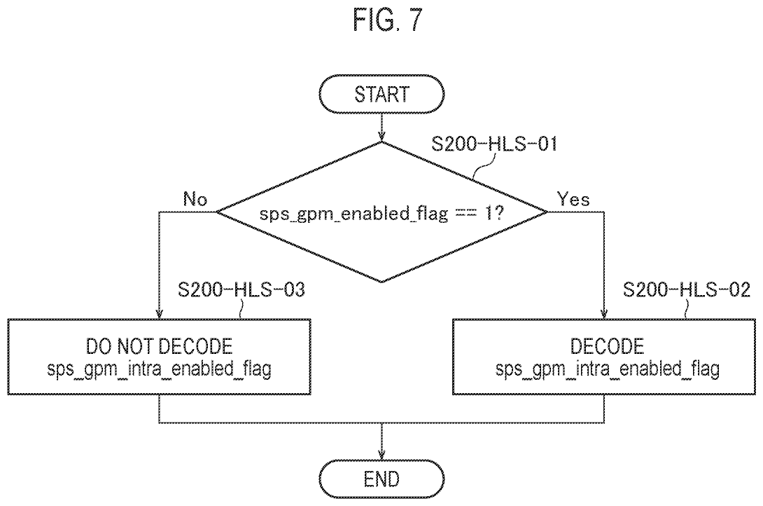

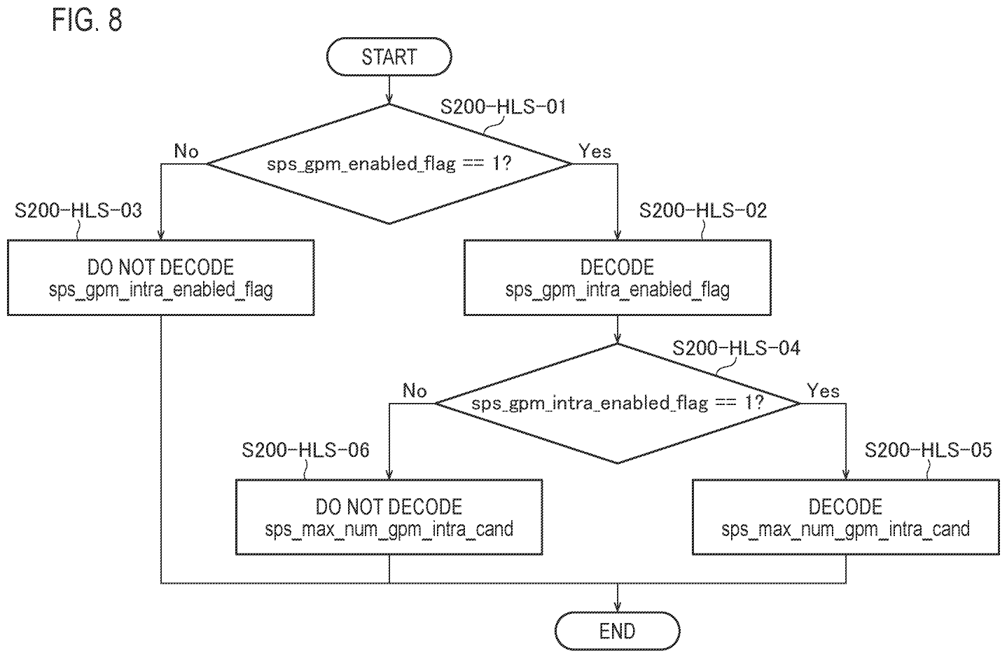

Hereinafter, a method in which the decoding unit 210 specifies whether the GPM can be applied based on the control data at the decoding target sequence level and whether the intra prediction mode can be applied to the GPM will be described with reference to FIGS. 7 and 8.

FIG. 7 is a flowchart illustrating an example of a method in which the decoding unit 210 specifies whether the GPM can be applied and whether the intra prediction mode can be applied to the GPM on the basis of the GPM-related flag in units of SPS.

As illustrated in FIG. 7, in step S200-HLS-01, the decoding unit 210 determines whether the value of sps_gpm_enabled_flag is 1.

When the value of sps_gpm_enabled_flag is 1, the decoding unit 210 proceeds to step S200-HLS-02. When the value of sps_gpm_enabled_flag is not 1, the decoding unit 210 proceeds to step S200-HLS-03.

Here, sps_gpm_enabled_flag is a syntax (first syntax) that controls whether the geometric partitioning mode of the decoding target sequence can be applied. When the value of sps_gpm_enabled_flag is 1, it indicates that GPM is enabled. When the value of sps_gpm_enabled_flag is 0, it indicates that GPM is disabled.

Note that the decoding unit 210 can determine the value of sps_gpm_enabled_flag in step S200-HLS-01 by decoding sps_gpm_enabled_flag before step S200-HLS-01.

Further, when sps_gpm_enabled_flag does not exist, the decoding unit 210 may infer the value of sps_gpm_enabled_flag as 0.

In step S200-HLS-02, the decoding unit 210 decodes sps_gpm_intra_enabled_flag, and this processing ends.

On the other hand, in step S200-HLS-03, the decoding unit 210 ends this processing without decoding sps_gpm_intra_enabled_flag.

Here, sps_gpm_intra_enabled_flag is a syntax (second syntax) that controls whether the intra prediction mode can be applied to the geometric partitioning mode of the decoding sequence. When the value of sps_gpm_intra_enabled_flag is 1, it indicates that the intra prediction mode can be applied to the GPM. When the value of sps_gpm_intra_enabled_flag is 0, it indicates that the intra prediction mode cannot be applied to the GPM.

Note that, when sps_gpm_intra_enabled_flag does not exist, the decoding unit 210 may infer the value of sps_gpm_intra_enabled_flag as 0.

The reason why the decoding unit 210 does not decode sps_gpm_intra_enabled_flag in step S200-HLS-03 is that since the value of sps_gpm_enabled_flag is 0, that is, it can be specified in the previous stage that GPM is not applicable in the decoding target sequence, there is no meaning to decode sps_gpm_intra_enabled_flag. By adopting this method, unnecessary decoding (encoding) of sps_gpm_intra_enabled_flag can be avoided.

FIG. 8 is a modified example of FIG. 7. Specifically, FIG. 8 is different from FIG. 7 in that, when there are a plurality of intra prediction modes that can be additionally applied to GPM, steps S200-HLS-04, S200-HLS-05, and S200-HLS-06 related to decoding determination of syntax (sps_max_num_gpm_intra_cand to be described later, third syntax) that defines which intra prediction mode can be selected in the partitioned region of the decoding target block and the maximum number of candidates (the number of types) are added.

As illustrated in FIG. 8, in step S200-HLS-04, the decoding unit 210 determines whether the value of sps_gpm_intra_enabled_flag is 1. When the value of sps_gpm_intra_enabled_flag is 1, the processing proceeds to step S200-HLS-05. When the value of sps_gpm_intra_enabled_flag is 0, the processing proceeds to step S200-HLS-06.

In step S200-HLS-05, the decoding unit 210 decodes sps_max_num_gpm_intra_cand, and this processing ends.

On the other hand, in step S200-HLS-06, the decoding unit 210 ends this processing without decoding sps_max_num_gpm_intra_cand.

In step S200-HLS-06, since it can be specified that the intra prediction mode cannot be applied to the GPM in the determination by sps_gpm_intra_enabled_flag in step S200-HLS-05, unnecessary decoding (encoding) of sps_max_num_gpm_intra_cand is avoided.

Here, the value of sps_max_num_gpm_intra_cand may be set to the maximum number of intra prediction mode types applied to GPM. When sps_max_num_gpm_intra_cand does not exist, the decoding unit 210 may infer the value of sps_max_num_gpm_intra_cand as 0.

The type of the intra prediction mode applied to the GPM is configured by the intra prediction mode corresponding to the partitioning line (for example, partitioning line L1 illustrated in FIG. 4) in the first GPM.

For example, the type of the intra prediction mode applied to the GPM may include an angular mode parallel to the partitioning line L1 in the GPM and/or an angular mode vertical to the partitioning line L1. Alternatively, the type of the intra prediction mode applied to the GPM may include the angular mode near these angular modes.

Note that, when there are two or more angular modes parallel to the partitioning line L1 or two or more angular modes vertical to the partitioning line L1 (for example, when the partitioning line L1 has the same angle as the diagonal line of the square block,), the type of the intra prediction mode applied to the GPM may be limited to either one.

For example, by adopting a method of limiting the decoding target block in the order of processing of adjacent decoded blocks, that is, by limiting the decoding target block to a direction in which reference pixels are acquired from an adjacent block on the left or above an adjacent block on the right or below the adjacent block, it is possible to reduce the dependency of decoding processing between blocks at the time of generating predicted pixels.

In addition, the type of the intra prediction mode applied to the GPM may include an intra prediction mode that does not depend on the partitioning line L1, for example, a planar mode, a DC mode, or the like, in addition to the angular mode.

Note that, in the above description, it has been described that the decoding necessity is determined at the sequence level with respect to the syntax for controlling the possibility of the application of the intra prediction mode to the geometric partitioning mode and the syntax for specifying the maximum number of candidates of the intra prediction mode type to be applied to the GPM. However, in order to perform control at a finer granularity, for example, decoding may be performed at the level of the PPS, the picture header, or the slice header.

However, since the code amount of the syntax to be decoded (encoded) increases when the control unit is finer, the design may be performed by evaluating the trade-off between the improvement of the prediction performance due to the finer control unit and the increase in the code amount of the syntax according to the designer's intention.

(Method of Determining Whether to Apply GPM in Units of Blocks)

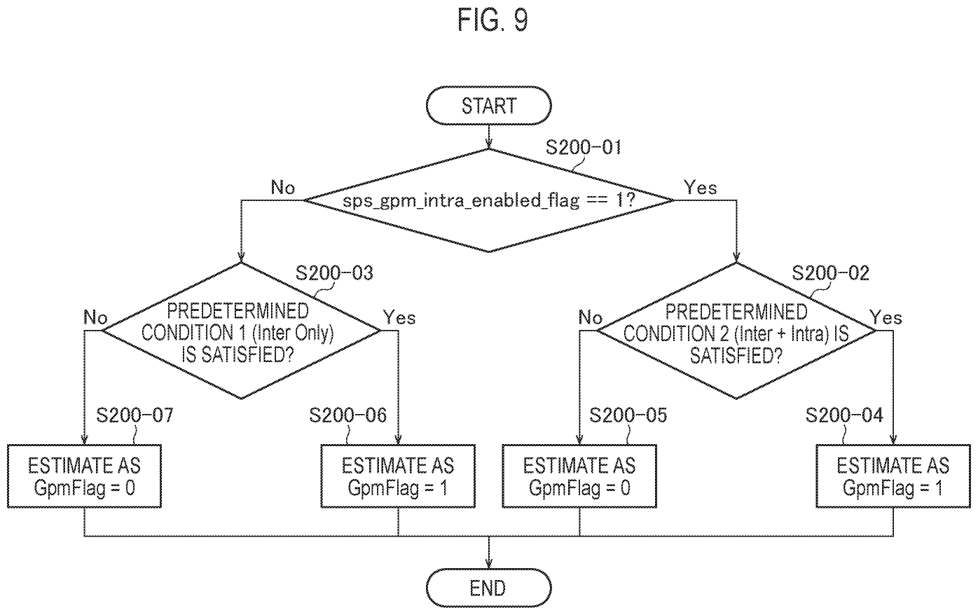

Hereinafter, whether the decoding unit 210 will apply the GPM to the decoding target block will be described with reference to FIG. 9. FIG. 9 is a flowchart illustrating an example of a method in which the decoding unit 210 determines whether to apply the GPM to the decoding target block.

As illustrated in FIG. 9, in step S200-01, the decoding unit 210 determines whether the value of sps_gpm_intra_enabled_flag is 1. When the value of sps_gpm_intra_enabled_flag is 1, the processing proceeds to step S200-2. When the value of sps_gpm_intra_enabled_flag is 0, the processing proceeds to step S200-03.

In step S200-03, the decoding unit 210 determines whether predetermined condition 1 (alternatively, the first predetermined condition) is satisfied. When predetermined condition 1 is satisfied, the decoding unit 210 proceeds to step S200-06. When predetermined condition 1 is not satisfied, the decoding unit 210 proceeds to step S200-07. Details of the predetermined condition 1 will be described later.

In step S200-06, the decoding unit 210 specifies the value of GpmFlag as 1 and ends this processing. In step S200-06, the decoding unit 210 specifies the value of GpmFlag as 0 and ends this processing.

Here, GpmFlag is an internal parameter (first internal parameter or second internal parameter) that specifies (controls) whether GPM is applied to the decoding target block. When the value of GpmFlag is 1, it indicates that GPM is applied to the decoding target block (GPM is enabled). When the value of GpmFlag is 0, it indicates that GPM is not applied to the decoding target block (GPM is disabled).

That is, it can be said that GpmFlag is an internal parameter (first internal parameter) that controls whether to apply the geometric partitioning mode to the decoding target block according to the predetermined condition 1.

Since the predetermined condition 1 is a condition for determining whether to apply the GPM to which the intra prediction mode is not applied, the same condition disclosed in Non Patent Reference 1 may be used. Specifically, all the following conditions are satisfied.
The value of sps_gpm_enabled_flag is 1.
sh_slice_type is B.
The value of general_merge_flag is 1.
The width of the decoding target block is 8 pixels or more.
The height of the decoding target block is 8 pixels or more.
The width of the decoding target block is less than 128 pixels.
The height of the decoding target block is less than 128 pixels.
The width of the decoding target block is less than eight times the height of the decoding target block.
The height of the decoding target block is less than eight times the width of the decoding target block.
The value of regular_merge_flag is 1.
The value of merge_subblock_flag is 0.
The value of clip_flag is 0.

Here, sh_slice_type is a syntax (fourth syntax) indicating a type of a decoding target slice, and in Non Patent Reference 1, two merge vectors different from each other for a GPM-applied block are used for generating a predicted pixel of each partitioned region. Therefore, sh_slice_type can be applied only to a B-slice in which it is obvious that there are two motion vectors in the entire slice (conversely, it means that GPM cannot be applied to a P-slice in which it is obvious that there is only one motion vector in the entire slice).

Here, various conditions regarding general_merge_flag, regular_merge_flag, merge_subblock_flag, and clip_flag can have the same configuration as in Non Patent Reference 1, and thus description thereof will be omitted.

In addition, the condition that the width and height of the decoding target block are eight pixels or more is intended to reduce the worst case of the number of reference pixels (memory bandwidth) required for motion compensation, and is introduced in Non Patent Reference 1. Specifically, in Non Patent Reference 1, the lower limit value of the block size of a uni-predictive block having one motion vector is set to 4×8/8×4 pixels, and the lower limit value of the block size of a bi-predictive block having two motion vectors is set to 8×8 pixels. Therefore, the same lower limit value is considered as an application condition for the GPM-applied block, which is a type of bi-predictive block.

The condition that the width and height of the decoding target block are less than 128 pixels is limited from the viewpoint of making GPM inapplicable to a block having a low application rate of GPM in order to reduce the number of times of tentative encoding processing for evaluating whether to apply GPM in the image encoding device 100, and eventually to reduce the encoding processing amount.

The condition that the width (or height) of the decoding target block is less than 8 times the height (or width) of the decoding target block is limited from the viewpoint of making GPM inapplicable to a block having a low application rate of GPM in order to reduce the number of times of tentative encoding processing for evaluating whether to apply GPM in the image encoding device 100, and eventually to reduce the encoding processing amount.

In contrast to step S200-03 described above, in step S200-02, the decoding unit 210 determines whether predetermined condition 2 (alternatively, the second predetermined condition) is satisfied. When predetermined condition 2 is satisfied, the decoding unit 210 proceeds to step S200-04. When predetermined condition 1 is not satisfied, the decoding unit 210 proceeds to step S200-05. Details of the predetermined condition 2 will be described later.

That is, it can also be said that GpmFlag is an internal parameter (second internal parameter) that controls whether to apply the geometric partitioning mode to the decoding target block according to the predetermined condition 2.

In step S200-04, the decoding unit 210 specifies the value of GpmFlag as 1 and ends this processing. In step S200-05, the decoding unit 210 specifies the value of GpmFlag as 0 and ends this processing.

Here, since the predetermined condition 2 is a condition for determining whether the GPM to which the intra prediction mode is applied is applied, the following condition included in the predetermined condition 1 may be eliminated.
sh_slice_type is B.
The width of the decoding target block is 8 pixels or more.
The height of the decoding target block is 8 pixels or more.
The width of the decoding target block is less than eight times the height of the decoding target block.
The height of the decoding target block is less than eight times the width of the decoding target block.

First, regarding the elimination of the condition related to sh_slice_type, the intra prediction mode to GPM enables GPM to be applied to the I-slice and the P-slice other than the B-slice. As a result, the number of blocks to which GPM is applied increases, and improvement in encoding performance can be expected.

For example, for the I-slice, the GPM in which the intra prediction mode is applied to both of the partitioned regions can be applied. Furthermore, for example, GPM in which the merge mode is applied to one of the partitioned regions and the intra prediction mode is applied to the other partitioned region can be applied to the P-slice.

Second, regarding the elimination of the condition that the width and height of the decoding target block are 8 pixels or more, when the intra prediction mode is applied to at least one of the partitioned regions of the GPM, the lower limit value (8×8 pixels) of the block size set in consideration of the memory bandwidth of the worst case of the bi-predictive block can be relaxed to the lower limit value (4×8/8×4 pixels) of the block size of the uni-predictive block. As a result, since the GPM can be applied to the small-size block to which the GPM cannot be applied in Non Patent Reference 1, the number of blocks to which the GPM is applied increases, and improvement in encoding performance can be expected.

Note that it is also assumed that the block size lower limit values of the uni-predictive block and the bi-predictive block themselves may be alleviated in the future by improving the memory bandwidth of the hardware decoder. However, even in such a case, the GPM by application of the intra prediction mode as described above can relax the block size limit (lower limit value) in consideration of the memory bandwidth of the worst case of the bi-predictive block in the conventional GPM to the block size limit (lower limit value) in the uni-prediction.

Third, regarding the elimination of the condition regarding the aspect ratio of the decoding target block (=elimination of condition that width (or height) of decoding target block is less than eight times height (or width) of decoding target block), if the prediction performance of the intra prediction mode is relaxed by being limited to a small-size block having a relatively high prediction performance by introduction of the intra prediction mode to the GPM, the number of blocks to which the GPM is applied increases, and improvement of the encoding performance can be expected.

For example, in Non Patent Reference 1, the restriction may be eliminated for a 4×16/16×4 pixel block and/or a 4×32/32×4 pixel block and/or an 8×64/64×8 pixel block to which GPM cannot be applied.

In addition, the condition that the width and height of the decoding target block are less than 128 pixels in the predetermined condition 1 and the predetermined condition 2 may be relaxed in the future due to the improvement in the performance of the encoder, but even in such a case, the same condition (block size upper limit value) for the GPM to which the intra prediction mode is applied may be maintained. This is because, in the intra prediction mode, as the block size increases, the distance from the left and upper adjacent reference pixels of the decoding target block increases, and thus, the prediction accuracy tends to decrease.

### (Method of Determining GPM Partitioning Mode (Type of Partitioning Line L1) in Units of Blocks)

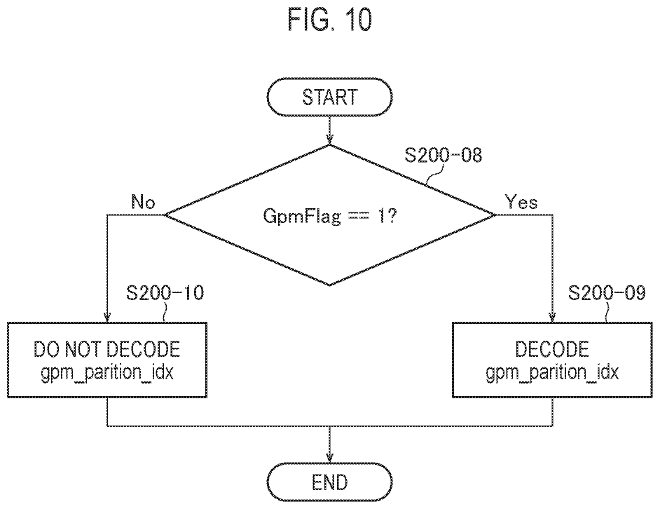

Hereinafter, a method in which the decoding unit 210 determines the GPM partitioning mode (the type of the partitioning line L1) in units of blocks will be described with reference to FIG. 10. FIG. 10 is a flowchart illustrating an example of a method in which the decoding unit 210 determines the GPM partitioning mode (the type of the partitioning line L1) in units of blocks of the decoding target block.

As illustrated in FIG. 10, in step S200-08, the decoding unit 210 determines whether the value of GpmFlag is 1. When the value of GpmFlag is 1, the processing proceeds to step S200-09. When the value of GpmFlag is 0, the processing proceeds to step S200-10.

In step S200-09, the decoding unit 210 decodes gpm_partition_idx included in the control data and ends this processing.

In step S200-10, the decoding unit 210 ends this processing without decoding gpm_partition_idx included in the control data.

Here, gpm_partition_idx is a syntax (fifth syntax) for specifying a partitioning shape (a direction of the partitioning line L1) of the geometric partitioning mode of the decoding target block.

In Non Patent Reference 1, since the value of 0 to 63 of gpm_partition_idx corresponds to the directions of the above-described sixty-four types of partitioning lines L1, the decoding unit 210 can specify (infer) the value of gpm_partition_idx to specify the partitioning shape (the direction of the partitioning line L1) of the geometric partitioning mode of the decoding target block.

Note that, in step S200-10, the decoding unit 210 ends this processing without decoding gpm_partition_idx included in the control data. This is intended to avoid unnecessary decoding of gpm_partition_idx (reduce the transmission code amount) since it can be specified that GPM is not applied to the decoding target block by the determination regarding GpmFlag in step S200-08.

(Method for Determining Whether to Apply Intra Prediction Mode in Partitioned Region 0)

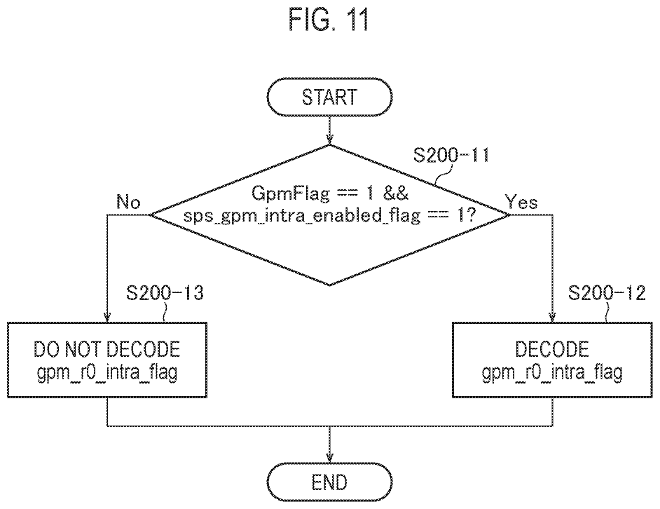

Hereinafter, a method in which the decoding unit 210 determines whether to apply the intra prediction mode in the partitioned region 0 will be described with reference to FIG. 11. FIG. 11 is a flowchart illustrating a method in which the decoding unit 210 determines whether to apply the intra prediction mode in the partitioned region 0.

As illustrated in FIG. 11, in step S200-11, the decoding unit 210 determines whether the value of GpmFlag is 1 and sps_gpm_intra_enabled_flag is 1. The decoding unit 210 proceeds to step S200-12 when such a condition is satisfied, and proceeds to step S200-13 when such a condition is not satisfied.

In step S200-12, the decoding unit 210 decodes gpm_r0_intra_flag included in the control data, and ends this processing.

In step S200-13, the decoding unit 210 ends this processing without decoding gpm_r0_intra_flag included in the control data.

Here, gpm_r0_intra_flag is a syntax (sixth syntax) for specifying whether the prediction mode of the partitioned region 0 in the geometric partitioning mode of the decoding target block is the intra prediction mode.

The decoding unit 210 can specify that the intra prediction mode is applied (enabled) to the partitioned region 0 when the value of gpm_r0_intra_flag is 1, and can specify that the intra prediction mode is not applied (disabled) to the partitioned region 0 when the value of gpm_r0_intra_flag is 0.

Note that, when gpm_r0_intra_flag does not exist, the decoding unit 210 may infer the value of gpm_r0_intra_flag as 0.

In step S200-13, the decoding unit 210 ends this processing without decoding gpm_r0_intra_flag included in the control data. This is intended to avoid unnecessary decoding of gpm_r0_intra_flag (reduce the transmission code amount) since it can be specified in the determination in step S200-11 that GPM is not applied to the decoding target block or that the intra prediction mode is not applied to GPM in the partitioned region 0 even if GPM is applied.

(Method for Determining Whether Intra Prediction Mode is Applied in Partitioned Region 1)

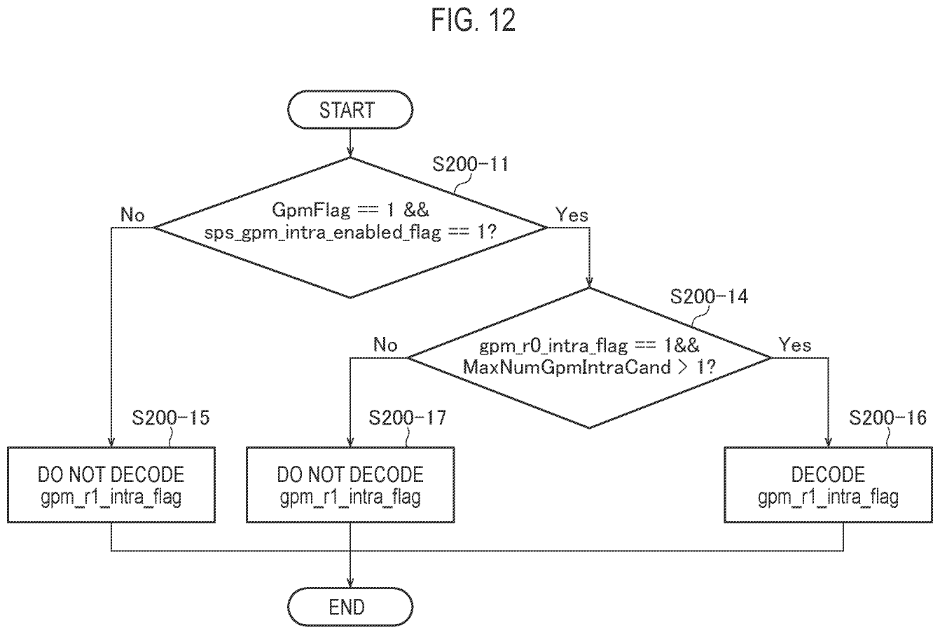

Hereinafter, a method in which the decoding unit 210 determines whether to apply the intra prediction mode in the partitioned region 1 will be described with reference to FIG. 12. FIG. 12 is a flowchart illustrating a method in which the decoding unit 210 determines whether to apply the intra prediction mode in the partitioned region 1.

As illustrated in FIG. 12, in step S200-11, the decoding unit 210 determines whether the value of GpmFlag is 1 and sps_gpm_intra_enabled_flag is 1. The decoding unit 210 proceeds to step S200-14 when such a condition is satisfied, and proceeds to step S200-15 when such a condition is not satisfied.

In step S200-14, the decoding unit 210 determines whether gpm_r0_intra_flag is 1 and MaxNumIntraCand is greater than 1. The decoding unit 210 proceeds to step S200-16 when such a condition is satisfied, and proceeds to step S200-17 when such a condition is not satisfied.

Here, MaxNumIntraCand is an internal parameter (third internal parameter) representing the maximum number of intra type candidates applicable to the geometric partitioning mode.

Regarding the maximum number, a fixed value calculated from the maximum number of intra type candidates applicable to the geometric partitioning mode may be set in advance in both the image encoding device 100 and the image decoding device 200, or a variable value may be dynamically set in units of decoding target sequences on the basis of sps_max_num_gpm_intra_cand transmitted from the image encoding device 100 to the image decoding device 200.

The decoding unit 210 ends this processing without decoding gpm_r1_intra_flag included in the control data in step S200-15, ends this processing by decoding gpm_r1_intra_flag included in the control data in step S200-16, and ends this processing without decoding gpm_r1_intra_flag included in the control data in step S200-17.

Here, gpm_r1_intra_flag is a syntax (seventh syntax) for specifying whether the prediction mode of the partitioned region 1 in the geometric partitioning mode of the decoding target block is the intra prediction mode.

When the value of gpm_r1_intra_flag is 1, the decoding unit 210 can specify that the intra prediction mode is applied (enabled) to partitioned region 1. When the value of gpm_r1_intra_flag is 0, the decoding unit 210 can specify that the intra prediction mode is not applied (disabled) to partitioned region 1.

Note that, when gpm_r1_intra_flag does not exist, the decoding unit 210 may infer the value of gpm_r1_intra_flag as 0.

In steps S200-15 and S200-17, the decoding unit 210 ends this processing without decoding gpm_r1_intra_flag included in the control data. This is intended to avoid unnecessary decoding of gpm_r1_intra_flag (reduce the transmission code amount) since it can be specified by the determination in steps S200-11 and S200-16 that GPM is not applied to the decoding target block or that the intra prediction mode is not applied to GPM even if GPM is applied to the partitioned region 1.

(Method for Specifying Prediction Mode in Partitioned Region 0 when there is One Type of GPM-Applied Intra Prediction Mode)

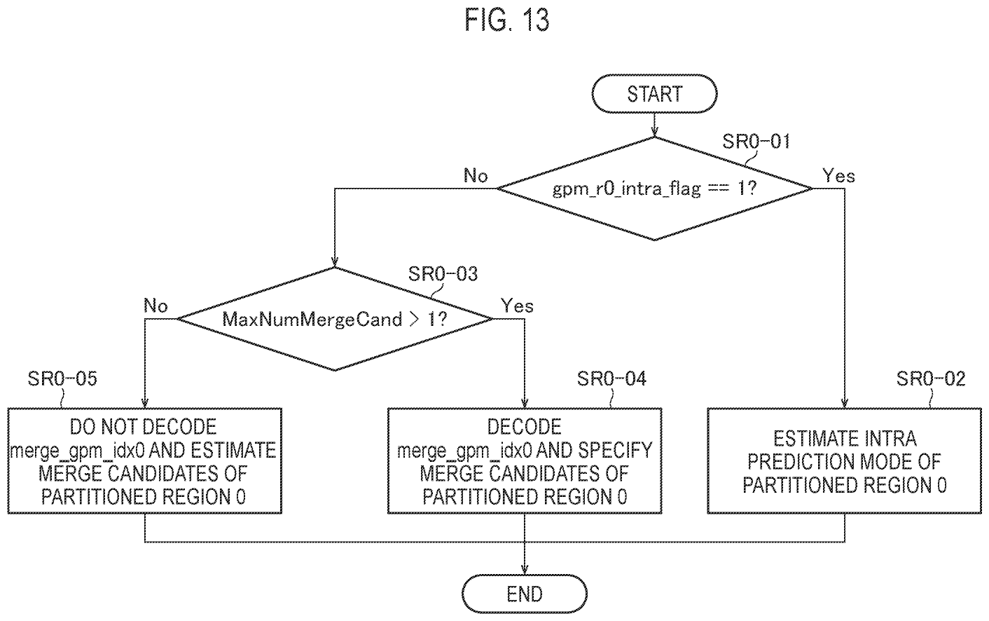

Hereinafter, a method in which the decoding unit 210 specifies the prediction mode in the partitioned region 0 when there is one type of GPM-applied intra prediction mode will be described with reference to FIG. 13. FIG. 13 is a flowchart illustrating an example of a method in which the decoding unit 210 specifies the prediction mode in the partitioned region 0 when there is one type of GPM-applied intra prediction mode.

As illustrated in FIG. 13, in step SR0-01, the decoding unit 210 determines whether the value of gpm_r0_intra_flag is 1. The decoding unit 210 proceeds to step SR0-02 when such a condition is satisfied, and proceeds to step SR0-03 when such a condition is not satisfied.

In step SR0-02, the decoding unit 210 specifies the intra prediction mode of the partitioned region 0 as one type of intra prediction mode applicable to GPM, and this processing ends.

In step SR0-03, the decoding unit 210 determines whether the value of MaxNumMergeCand is greater than 1. The decoding unit 210 proceeds to step SR0-04 when such a condition is satisfied, and proceeds to step SR0-05 when such a condition is not satisfied.

Here, MaxNumMergeCand is an internal parameter (fourth internal parameter) representing the maximum number of merge candidates in the normal merge mode. Since the same configuration as the setting method disclosed in Non Patent Reference 1 can be used in the present embodiment, the maximum number will not be described in detail.

In step SR0-04, the decoding unit 210 decodes merge_gpm_idx0, specifies a merge candidate for the partitioned region 0, and ends this processing.

In step SR0-05, the decoding unit 210 does not decode merge_gpm_idx0, specifies a merge candidate for the partitioned region 0, and ends this processing.

Here, merge_gpm_idx0 is an index (merge index) that specifies a merge candidate for the partitioned region 0.

When merge_gpm_idx0 does not exist, the decoding unit 210 may infer the value of merge_gpm_idx0 as 0.

Here, in step SR0-05, the decoding unit 210 ends this processing without decoding merge_gpm_idx0, but in step SR0-03. This is intended to avoid unnecessary decoding (reduce the transmission code amount) of merge_gpm_idx0 since it can be specified that MaxNumMergeCand is 1, that is, the merge candidate for the partitioned region 0 can be specified as 0.

(Method for Specifying Prediction Mode in Partitioned Region 1 when there is One Type of GPM-Applied Intra Prediction Mode)

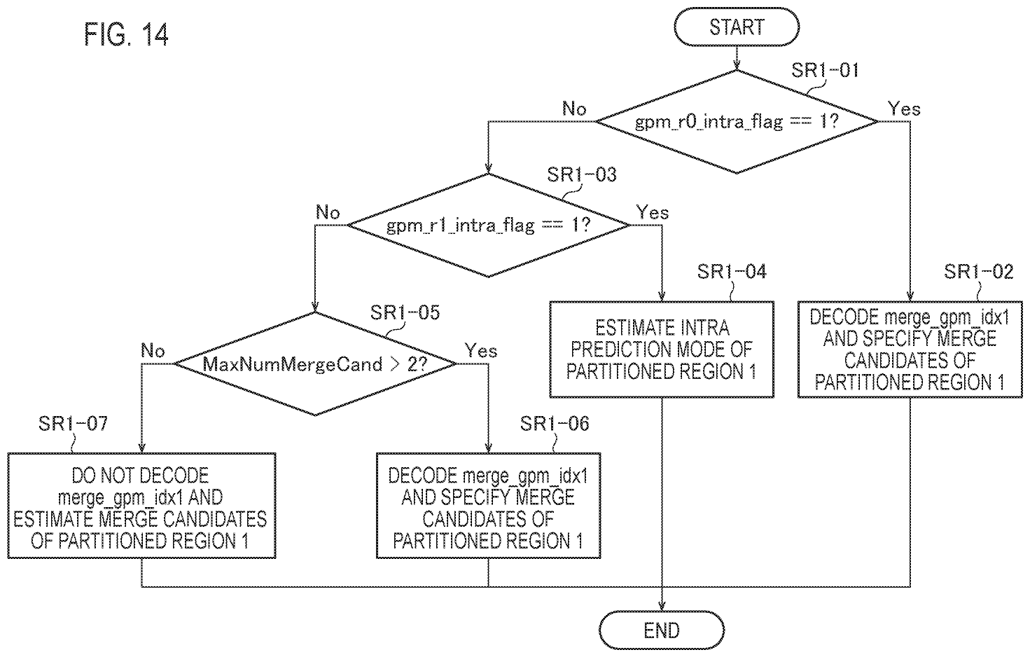

Hereinafter, a method in which the decoding unit 210 specifies a prediction mode in the partitioned region 1 when there is one type of GPM-applied intra prediction mode will be described with reference to FIG. 14. FIG. 14 is a flowchart illustrating an example of a method in which the decoding unit 210 specifies a prediction mode in the partitioned region 1 when there is one type of GPM-applied intra prediction mode.

As illustrated in FIG. 14, in step SR1-01, the decoding unit 210 determines whether the value of gpm_r0_intra_flag is 1. The decoding unit 210 proceeds to step SR1-02 when such a condition is satisfied, and proceeds to step SR1-03 when such a condition is not satisfied.

In step SR1-02, the decoding unit 210 decodes merge_gpm_idx1, specifies a merge candidate for the partitioned region 1, and ends this processing.

In step SR1-03, the decoding unit 210 determines whether the value of gpm_r1_intra_flag is 1. The decoding unit 210 proceeds to step SR1-04 when such a condition is satisfied, and proceeds to step SR1-05 when such a condition is not satisfied.

In step SR1-04, the decoding unit 210 specifies the intra prediction mode of the partitioned region 1 as one type of intra prediction mode applicable to GPM, and this processing ends.

In step SR1-05, the decoding unit 210 determines whether the value of MaxNumMergeCand is greater than 2. The decoding unit 210 proceeds to step SR1-06 when such a condition is satisfied, and proceeds to step SR1-07 when such a condition is not satisfied.

In step SR1-06, the decoding unit 210 decodes merge_gpm_idx1, specifies a merge candidate for the partitioned region 1, and ends this processing.

In step SR1-07, the decoding unit 210 does not decode merge_gpm_idx1, specifies a merge candidate for the partitioned region 1, and ends this processing.

Here, merge_gpm_idx1 is an index (merge index) that specifies a merge candidate for the partitioned region 1.

merge_gpm_idx1 does not exist, the decoding unit 210 may infer the value of merge_gpm_idx1 as 0.

Here, in step SR1-07, the decoding unit 210 ends this processing without decoding merge_gpm_idx1. This is intended to avoid unnecessary decoding of merge_gpm_idx1 (reduce the transmission code amount) since it can be specified in step SR1-05 that the value of MaxNumMergeCand is 2, that is, it can be specified that the merge candidate for the partitioned region 1 is a merge candidate different from the merge candidate for the partitioned region 0 specified on the basis of merge_gpm_idx0 among the two merge candidates.

(Method for Specifying Prediction Mode in Partitioned Region 0 when there are Two or More Types of GPM-Applied Intra Prediction Modes)

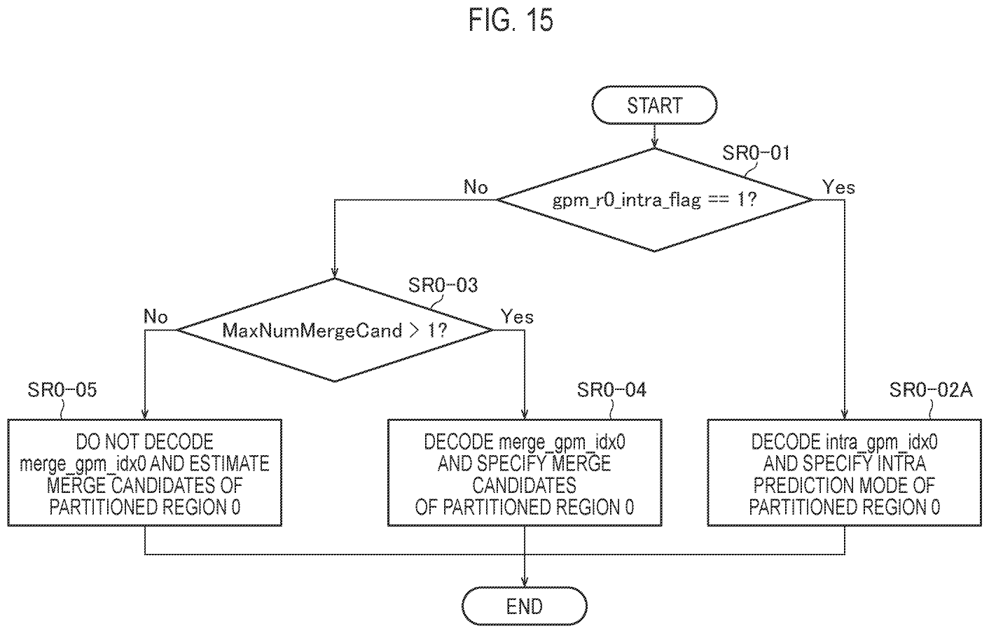

Hereinafter, a method in which the decoding unit 210 specifies a prediction mode in the partitioned region 0 when there are two or more types of GPM-applied intra prediction modes will be described with reference to FIGS. 13 and 15. FIG. 15 is a flowchart illustrating an example of a method in which the decoding unit 210 specifies the prediction mode in the partitioned region 0 when there are two or more types of GPM-applied intra prediction modes.

Here, since the difference between the flowchart illustrated in FIG. 15 and the flowchart illustrated in FIG. 13 is only step SR0-02 and step SR0-02A, only the difference between the two steps will be described.

In the flowchart illustrated in FIG. 13, it is assumed that there is one type of GPM-applied intra prediction mode. In step SR0-02, when the prediction mode of the partitioned region 0 can be specified as the intra prediction mode in step SR001, the decoding unit 210 can uniquely specify that the type of the intra prediction mode is one type of GPM-applied intra prediction mode.

On the other hand, in the flowchart illustrated in FIG. 15, it is assumed that there are two or more types of GPM-applied intra prediction modes. In step SR0-02A, the decoding unit 210 decodes intra_gpm_idx0 since the type of the intra prediction mode of the partitioned region 0 cannot be specified unless intra_gpm_idx0 is decoded even when the prediction mode of the partitioned region 0 can be specified as the intra prediction mode in step SR0-01.

Here, intra_gpm_idx0 is a syntax (eighth syntax) for specifying (controlling) the type of the intra prediction mode in the partitioned region 0.

The variation of the value of intra_gpm_idx0 may be set according to the number of types of intra prediction modes applicable to GPM.

Further, the type of the intra prediction mode corresponding to the value of intra_gpm_idx0 may be set from the selectivity of the intra prediction mode in GPM.

For example, when there are two types of intra prediction modes: a parallel angular mode for the GPM partitioning line L1 and a vertical angular mode for the GPM partitioning line L1, the parallel angular mode having a high selectivity among the two types may be set to 0 of the value of intra_gpm_idx0, and the vertical angular mode having a low selectivity may be set to 1 of the value of intra_gpm_idx0.

As another example, when there are three types of intra prediction modes, that is, the parallel angular mode for the GPM partitioning line L1, the vertical angular mode for the GPM partitioning line L1, and the planar mode, the parallel angular mode may be set to 0 of the value of intra_gpm_idx0, the planar mode may be set to 1 of the value of intra_gpm_idx0, and the vertical angular mode may be set to 2 of the value of intra_gpm_idx0 in the descending order of the selectivities.

Note that, regarding the above-described selectivity, a value confirmed by a simulation experiment using reference software corresponding to the technology disclosed in Non Patent Reference 1 performed by the inventors is referred to, and the designer may change the selectivity according to software to be used, a simulation condition, or a target video sequence.

(Method for Specifying Prediction Mode in Partitioned Region 1 when there are Two or More Types of GPM-Applied Intra Prediction Modes)

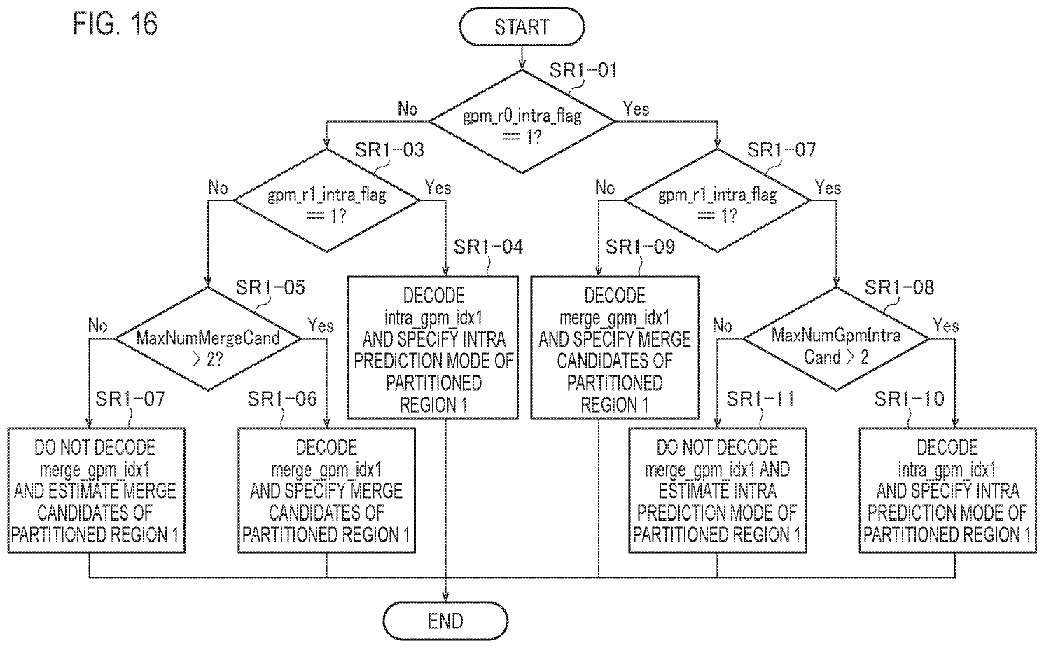

Hereinafter, a method in which the decoding unit 210 specifies a prediction mode in the partitioned region 1 when there are two or more types of GPM-applied intra prediction modes will be described with reference to FIGS. 14 and 16. FIG. 16 is a flowchart illustrating an example of a method in which the decoding unit 210 specifies a prediction mode in the partitioned region 1 when there are two or more types of GPM-applied intra prediction modes.

Here, the difference of the flowchart illustrated in FIG. 16 from the flowchart illustrated in FIG. 14 is that step SR1-02 of the flowchart illustrated in FIG. 14 is replaced with steps SR1-07 to SR1-11 in the flowchart illustrated in FIG. 16. Only this difference will be described.

In the flowchart illustrated in FIG. 14, it is assumed that there is one type of GPM-applied intra prediction mode. In step SR1-02, when the prediction mode of the partitioned region 0 can be specified as the intra prediction mode in step SR1-01, the decoding unit 210 can specify that the intra prediction mode is obviously not applied to the partitioned region 1, and thus merge candidates are specified by merge_gpm_idx1.

On the other hand, in the flowchart illustrated in FIG. 16, it is assumed that there are two or more types of GPM-applied intra prediction modes. Even if the prediction mode of the partitioned region 0 can be specified as the intra prediction mode in step SR1-01, the decoding unit 210 cannot specify whether the prediction mode of the partitioned region 1 is the intra prediction mode unless the value of gpm_r1_intra_flag is further determined to be 1 in step SR1-07.

Therefore, in step SR1-07, the decoding unit 210 determines whether the value of gpm_r1_intra_flag is 1. When the value of gpm_r1_intra_flag is 1, the processing proceeds to step SR1-08. When the value of gpm_r1_intra_flag is 0, the processing proceeds to step SR1-09.

In step SR1-09, the decoding unit 210 decodes merge_gpm_idx1, specifies a merge candidate for the partitioned region 1, and ends this processing.

In step SR1-08, the decoding unit 210 determines whether the value of MaxNumMergeCand is greater than 2. When such a condition is satisfied, the processing proceeds to step SR1-10. When such a condition is not satisfied, the processing proceeds to step SR1-11.

In step SR1-10, the decoding unit 210 decodes intra_gpm_idx1, specifies the type of the intra prediction mode for the partitioned region 1, and this processing ends.

In step SR1-11, the decoding unit 210 specifies the type of the intra prediction mode for the partitioned region 1 without decoding intra_gpm_idx1, and ends this processing.

In step SR1-11, the decoding unit 210 specifies the type of the intra prediction mode for the partitioned region 1 without decoding intra_gpm_idx1. This is intended to avoid unnecessary decoding of merge_gpm_idx1 (reduce the transmission code amount) since it can be specified that the value of MaxNumMergeCand is 2 in step SR1-08, that is, it can be specified that the merge candidate for the partitioned region 1 is a merge candidate different from the merge candidate for the partitioned region 0 specified based on merge_gpm_idx0 among the two merge candidates.

Here, intra_gpm_idx1 is a syntax (ninth syntax) for specifying the type of the intra prediction mode in the partitioned region 1.

The variation of the value of intra_gpm_idx1 may be set according to the number of types of intra prediction modes applicable to GPM.

Further, the type of the intra prediction mode corresponding to the value of intra_gpm_idx1 may be set from the selectivity of the intra prediction mode in GPM.

For example, when there are two types of intra prediction modes: a parallel angular mode for the GPM partitioning line L1 and a vertical angular mode for the GPM partitioning line L1, the parallel angular mode having a high selectivity among the two types may be set to 0 of the value of intra_gpm_idx1, and the vertical angular mode having a low selectivity may be set to 1 of the value of intra_gpm_idx1.

As another example, when there are three types of intra prediction modes, that is, the parallel angular mode for the GPM partitioning line L1, the vertical angular mode for the GPM partitioning line L1, and the planar mode, the parallel angular mode may be set to 0 of the value of intra_gpm_idx1, the planar mode may be set to 1 of the value of intra_gpm_idx1, and the vertical angular mode may be set to 2 of the value of intra_gpm_idx1 in the descending order of the selectivities.

Note that, regarding the above-described selectivity, a value confirmed by a simulation experiment using reference software corresponding to the technology disclosed in Non Patent Reference 1 performed by the inventors is referred to, and the designer may change the selectivity according to software to be used, a simulation condition, or a target video sequence.

The decoding unit 210 sends the following information in the decoding target sequence and the decoding target block specified by the methods described above with reference to FIGS. 7 to 16 to the inter prediction unit 241, the intra prediction unit 242, and the synthesizing unit 243. Therefore, in the image decoding device 200, application of the GPM in the decoding target block is appropriately specified and the type of the prediction mode for each partitioned region at the time of application of the GPM is appropriately specified, whereby further improvement of the encoding performance by the GPM can be expected.
Information regarding the possibility of application of GPM in units of sequences
information about whether GPM is applied in units of blocks
Information regarding GPM partitioning mode (type of partitioning line L1) in units of blocks
Information about whether intra prediction mode is applied in partitioned region 0
Method for determining whether intra prediction mode is applied to partitioned region 1
Method for specifying prediction mode in partitioned region 0 when there is one type of GPM-applied intra prediction mode
Method for specifying prediction mode in partitioned region 1 when there is one type of GPM-applied intra prediction mode
Method for specifying prediction mode in partitioned region 0 when there are two or more types of GPM-applied intra prediction modes
Method for specifying prediction mode in partitioned region 1 when there are two or more types of GPM-applied intra prediction modes

Note that, in the above description, the signaling method at the time of applying the intra prediction mode to the GPM in that case has been described with reference to the case where the rectangular block is partitioned into two parts by the GPM. However, the signaling method described in the present embodiment can be applied to a case where the rectangular block is partitioned into three or more parts by the GPM in a similar concept.

Further, the image encoding device 100 and the image decoding device 200 may be realized as a program causing a computer to execute each function (each step).

Note that the above described embodiments have been described by taking application of the present invention to the point cloud encoding device 10 and the point cloud decoding device 30 as examples. However, the present invention is not limited only thereto, but can be similarly applied to an encoding/decoding system having functions of the encoding device 10 and the decoding device 30.

According to the present embodiment, it is possible to improve the overall quality of service in video communications, thereby contributing to Goal 9 of the UN-led Sustainable Development Goals (SDGs) which is to “build resilient infrastructure, promote inclusive and sustainable industrialization and foster innovation”.

1. An image decoding device comprising a circuit, wherein the circuit decodes a first syntax for controlling possibility of application of a geometric partitioning mode of a decoding target sequence, and controls whether to decode a second syntax for controlling possibility of application of an intra prediction mode to the geometric partitioning mode of the decoding target sequence according to a value of the first syntax.

2. The image decoding device according to claim 1, wherein the circuit:
decodes the second syntax when the value of the first syntax is 1; and
does not decode the second syntax when the value of the first syntax is not 1.

3. The image decoding device according to claim 1, wherein the circuit:
decodes a third syntax for controlling a number of types of intra prediction modes applicable to the geometric partitioning mode of the decoding target sequence when the value of the second syntax is 1; and
does not decode the third syntax when the value of the second syntax is not 1.

4. The image decoding device according to claim 1, wherein the circuit:
infers a value of a first internal parameter for controlling whether to apply the geometric partitioning mode to a decoding target block under a first predetermined condition when the value of the second syntax is not 1; and
infers a value of a second internal parameter for controlling whether to apply the geometric partitioning mode to the decoding target block under a second predetermined condition when the value of the second syntax is 1.

5. The image decoding device according to claim 4, wherein the second predetermined condition includes a condition that a fourth syntax indicating a type of a decoding target slice is a B-slice or a P-slice.

6. The image decoding device according to claim 4, wherein the circuit:
decodes a fifth syntax specifying a partitioning shape of the geometric partitioning mode of the decoding target block when the value of the first internal parameter or the second internal parameter is 1; and
does not decode the fifth syntax when the value of the first internal parameter or the second internal parameter is not 1.

7. The image decoding device according to claim 6, wherein the circuit:
decodes a sixth syntax specifying whether a prediction mode of a first partitioned region to be partitioned in the geometric partitioning mode of the decoding target block is an intra prediction mode when the first internal parameter or the second internal parameter is valid and a value of the second syntax is 1; and
does not decode the sixth syntax when the first internal parameter or the second internal parameter is valid and a condition that the value of the second syntax is 1 is not satisfied.

8. The image decoding device according to claim 7, wherein the circuit:
when the first internal parameter or the second internal parameter is valid and the value of the second syntax is 1:
decodes a seventh syntax specifying whether a prediction mode of a second partitioned region to be partitioned in the geometric partitioning mode of the decoding target block is an intra prediction mode when the sixth syntax is valid and a third internal parameter representing a maximum number of intra types of the geometric partitioning mode is greater than 1; and
does not decode the seventh syntax when the sixth syntax is valid and a condition that the third internal parameter is greater than 1 is not satisfied, and
does not decode the seventh syntax when a condition that the first internal parameter or the second internal parameter is valid and the value of the second syntax is 1 is not satisfied.

9. The image decoding device according to claim 7, wherein the circuit:
when there is one type of intra prediction mode applicable to the geometric partitioning mode of the decoding target block:
infers the prediction mode of the first partitioned region as the one type of intra prediction mode when the value of the sixth syntax is 1; and
when the value of the sixth syntax is not 1:
decodes a merge index for the first partitioned region and specifies a merge candidate of the first partitioned region when a value of a fourth internal parameter representing a maximum number of merge candidates of the decoding target block is greater than 1; and
does not decode the merge index for the first partitioned region and specify the merge candidate of the first partitioned region when the value of the fourth internal parameter is equal to or less than 1.

10. The image decoding device according to claim 9, wherein the circuit:
when there is one type of intra prediction mode applicable to the geometric partitioning mode of the decoding target block:
infers a prediction mode of the second partitioned region as an inter prediction mode, decodes a merge index for the second partitioned region, and specifies a merge candidate of the second partitioned region, when the value of the sixth syntax is 1; and
when the value of the sixth syntax is not 1:
specifies the prediction mode of the second partitioned region as the one type of intra prediction mode when a value of a seventh syntax for specifying whether the prediction mode of the second partitioned region to be partitioned in the geometric partitioning mode of the decoding target block is an intra prediction mode is 1; and
when a value of the seventh syntax is not 1:
decodes the merge index for the second partitioned region and specifies the merge candidate of the second partitioned region when a maximum number of merge candidates of the decoding target block is greater than 2; and
does not decode the merge index for the second partitioned region and specify the merge candidate of the second partitioned region when the maximum number of merge candidates of the decoding target block is equal to or less than 2.

11. The image decoding device according to claim 8, wherein the circuit:
when at least two types of intra prediction modes are applicable to the geometric partitioning mode of the decoding target block:
decodes an eighth syntax for controlling a type of an intra prediction mode of the first partitioned region and specifies the intra prediction mode of the first partitioned region when the value of the sixth syntax is 1; and
when a value of the sixth syntax is not 1:
decodes a merge index for the first partitioned region and specifies a merge candidate of the first partitioned region when a value of a fourth internal parameter representing a maximum number of merge candidates of the decoding target block is greater than 1; and
does not decode the merge index for the first partitioned region and specify the merge candidate of the first partitioned region when the value of the fourth internal parameter is equal to or less than 1.

12. The image decoding device according to claim 8, wherein the circuit:
when at least two types of intra prediction modes are applicable to the geometric partitioning mode of the decoding target block:
when a value of the sixth syntax is 1:
decodes a ninth syntax for controlling a type of an intra prediction mode of the second partitioned region and specifies the intra prediction mode of the second partitioned region when a value of the seventh syntax is 1 and a value of a sixth internal parameter representing a maximum number of intra types of the geometric partitioning mode is greater than 2;
does not decode the ninth syntax and specify the intra prediction mode of the second partitioned region when the sixth internal parameter is equal to or less than 2; and
decodes a merge index for the second partitioned region and specifies a merge candidate of the second partitioned region when the value of the sixth syntax is not 1; and
when a value of the sixth syntax is not 1:
decodes the ninth syntax and specifies the intra prediction mode of the second partitioned region when the value of the seventh syntax is 1; and
when a value of the seventh syntax is not 1:
decodes the merge index for the second partitioned region and specifies the merge candidate of the second partitioned region when a value of a fourth internal parameter representing a maximum number of merge candidates of the decoding target block is greater than 2; and
does not decode the merge index for the second partitioned region and specify the merge candidate of the partitioned second region when the value of the fourth internal parameter is 2 or less.

13. An image decoding method, comprising:
decoding a first syntax for controlling possibility of application of a geometric partitioning mode of a decoding target sequence; and
controlling whether to decode a second syntax for controlling possibility of application of an intra prediction mode to the geometric partitioning mode of the decoding target sequence according to a value of the first syntax.

14. A program stored on a non-transitory computer-readable medium for causing a computer to function as an image decoding device, the image decoding device comprising a circuit, wherein:
the circuit decodes a first syntax for controlling possibility of application of a geometric partitioning mode of a decoding target sequence, and controls whether to decode a second syntax for controlling possibility of application of an intra prediction mode to the geometric partitioning mode of the decoding target sequence according to a value of the first syntax.
